(19) United States
(12) Patent Application Publication
(10) Pub. No.: US 2015/0154669 A1
(43) Pub. Date: Jun. 4, 2015

(54) ACTUAL TIME BASED PARKING MANAGEMENT METHODS, SYSTEMS AND PROCESSOR-READABLE MEDIA

(71) Applicant: Xerox Corporation, Norwalk, CT (US)

(72) Inventors: Wencheng Wu, Webster, NY (US); Edul N. Dalal, Webster, NY (US); Yao Rong Wang, Webster, NY (US)

(73) Assignee: Xerox Corporation, Norwalk, CT (US)

(21) Appl. No.: 14/095,159

(22) Filed: Dec. 3, 2013

(51) Int. Cl. G06Q 30/02; G06Q 10/02

(52) U.S. Cl. CPC G06Q 30/0284; G06Q 10/02

(57) ABSTRACT

A time based parking management method, system and processor-readable media. A video-based parking occupancy detection unit can operate in association with an image-assisted parking kiosk to provide an automatic parking-time monitoring element. An image with respect to a vehicle parked onsite (e.g., parking lot, street side parking, etc.) can be captured via an image-capturing unit associated with the video-based parking occupancy detection unit and/or the image-assisted parking kiosk. The vehicle can be identified based on input provided to a GUI associated with the parking kiosk with said image displayed to initiate a parking session. A parking fee can be calculated based on the actual time parked and payment can be made by at least one payment mode after said parking session terminates.

### FIELD OF THE INVENTION

Embodiments are generally related to the field of parking management. Embodiments are also related to video-based parking occupancy detection systems and applications thereof. Embodiments are additionally related to actual time based parking management.

### BACKGROUND

A balance between supply and demand must be determined to meet the parking requirements of motorists. The ability to efficiently allocate and manage on-street parking remains elusive, even when parking requirements are significant, recurring, and known ahead of time. For instance, urban parking spaces characteristically undergo periods of widely skewed demand and utilization with low demand and light use in some periods, often during the night, and heavy demand and use at other times. Real-time parking occupancy detection systems are an emerging technology in parking management.

Most on-street parking management systems (e.g., parking meters, parking kiosk, etc.) utilize some form of a pre-paid model in which a user pre-pays an estimated amount. Such a charging model may result, however, in unsatisfactory situations such as over-payment for the parking duration, receiving a violation ticket due to under-payment for the parking duration, etc. Such parking systems include features such as, for example, bill reading, credit card and pre-paid card processing, and printing. As well, simple messages such as parking rate can be displayed on a display panel. Some parking systems permit new payment approaches such as pay-by-plate, which permits the user to input a license plate number and to make changes in a parking spot within a purchased parking time. Parking enforcement officers can scan through the street and then utilize license plate recognition to determine if the driver purchased adequate parking time. Such prior art approaches cannot apply a time based charge model as they lack an automatic parking-time monitoring element.

Based on the foregoing, it is believed that a need exists for an improved time based parking management method, system and processor-readable, as will be described in greater detail herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved parking management methods, systems and processor-readable media.

It is another aspect of the disclosed embodiments to provide for it improved video-based parking occupancy detection techniques.

It is a further aspect of the disclosed embodiments to provide for an improved parking kiosk.

It is yet another aspect of the disclosed embodiments to provide for an improved actual time based parking management method, system and processor-readable media.

The aforementioned aspects and other objectives and advantages can now be achieved as described herein. Actual time based parking management methods and systems are disclosed herein. A video-based parking occupancy detection unit can operate in association with an image-assisted parking kiosk in order to provide an automatic parking-time monitoring element. An image with respect to a vehicle parked onsite (e.g., a parking lot, street side parking, etc.) can be captured via an image-capturing unit associated with the video-based parking occupancy detection unit and/or the image-assisted parking kiosk. The vehicle can be identified via the image displayed on a Graphical User Interface (GUI) associated with the parking kiosk to initiate a parking session. A parking fee can be calculated based on an actual time parked and payment can be made by one or more payment modes (e.g, cash, credit card, debit card, pre-paid cash card, user account, etc.) after ending the parking session utilizing the vehicle image displayed on the GUI or automatically detected by a video-based parking occupancy detection unit.

The parking kiosk can be augmented with an image display capability and a plurality of functions such as, for example, touch screen, mouse, and/or selecting and entering buttons. A single-level or multi-level GUI can be implemented to initiate/end the parking session. A pre-determined cash deposit can be made utilizing a payment card and/or deducted from an account (for pre-registered users). The payment card (credit/debit) swiped may not be charged until a user or a video-based parking occupancy detection unit ends the parking session and any excess cash deposit remaining after deducting the computed parking fee can be refunded after ending the parking session. The kiosk can be integrated with an automatic license-plate recognition (ALPR) unit in order to track and provide evidence of parking usage after ending the parking session based on the actual time parked thereby deterring abuse, providing a layer of security, and to provide an automated billing system for the registered user.

A user image can be employed to automatically re-identify the user's vehicle while ending the parking session and serve as evidence in case of non-payment or future payment dispute. The system can be easily augmented to include pre-registered mobile communications device parkers. The parking occupancy detection unit can transmit a snapshot of the parking region of interest monitored by the parking management system per request from the parking kiosk and the parking kiosk can transmit the information of vehicle identification from the user. The information between the kiosk and the parking occupancy detection unit can be compared to enforce parking regulations and reservations, or safeguard against errors of the parking occupancy detection unit. The detected vehicle identification can be presented in a form of at least one of, for example, a color coding scheme, a highlighting with a box, and text messages based on the information to speed up the process and provide a better user experience.

A theft and vandalism detection feature or option can also be offered via the GUI associated with the parking kiosk. Similarly, reservations can be implemented via a computer network (e.g., Internet) and executed, and the reservation information can be visually posted on the display of the kiosk and also made known to other (non-reserved) parkers. The system does not place additional requirements on the user and requires minimal changes to current existing parking kiosks while offering the preferred actual time based parking charge model.

Optionally, the system may examine the parked vehicle and provide feedback to the user when the parking is unacceptable. The user can re-park the vehicle before the parking request is accepted by the kiosk. The actual time based parking charge model is especially suitable for a non-dosed arrangement such as on-street parking management, via user-initiated parking sessions, enabled by image-based presentation at the parking kiosk and communication between the kiosk and the video-based parking occupancy detection unit.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a data-processing system, in which an embodiment may be implemented;

FIG. 2 illustrates a schematic view of a software system including an actual time based parking management module, an operating system, and a user interface, in accordance with the disclosed embodiments;

FIG. 3 illustrates a block diagram of an actual time based parking management system, in accordance with the disclosed embodiments;

FIG. 4 illustrates a high level flow chart of operations illustrating logical operational steps of a method for providing actual time based parking charge model by integrating a video-based parking occupancy detection unit and an image-assisted parking kiosk, in accordance with the disclosed embodiments; and

FIGS. 5-6 illustrate a multi-level graphical user interface of the parking kiosk, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

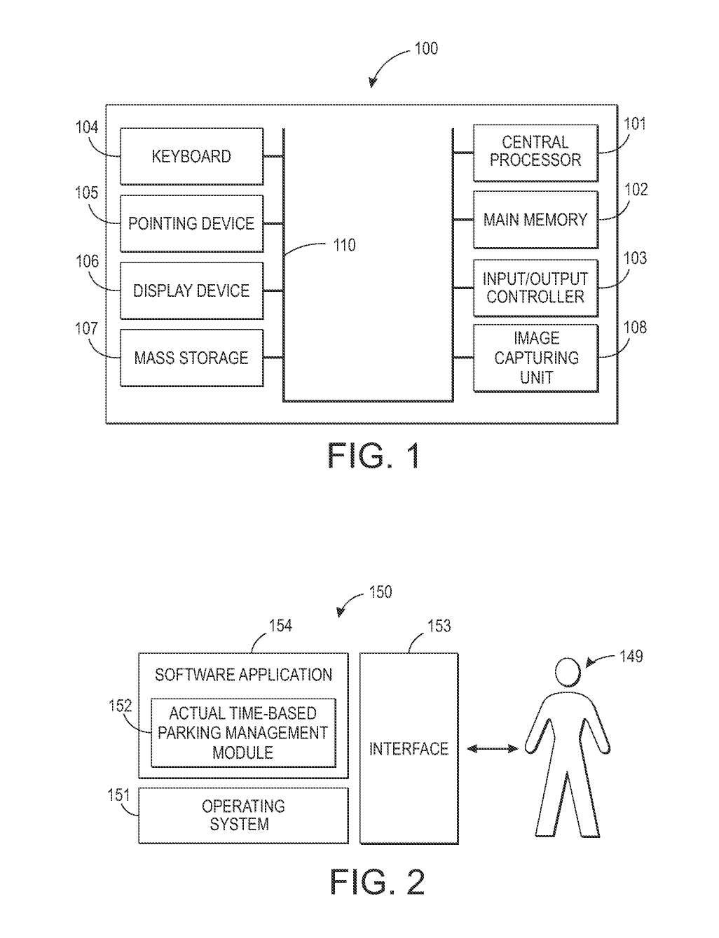

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a system bus 110, a central processor 101, a main memory 102, an input/output controller 103, a keyboard 104, an input device 105 (e.g., a pointing device such as a mouse, track ball, and pen device, etc.), a display device 106, a mass storage 107 (e.g., a hard disk), and an image-capturing unit 108. In some embodiments, for example, a USB peripheral connection (not shown in FIG. 1) and/or other hardware components may also be in electrical communication with the system bus 110 and components thereof. As illustrated, the various components of data-processing system 100 can communicate electronically through the system bus 110 or a similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

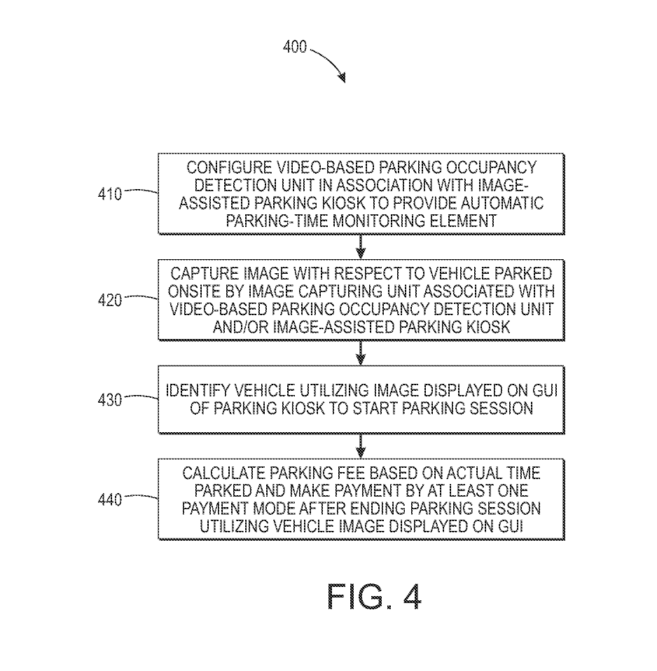

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include a time based parking management module 152 for providing time based parking charge model. Software application 154, on the other hand, can include instructions such as the various operations described herein with respect to the various components and modules described herein such as, for example, the method 400 depicted in FIG. 4.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

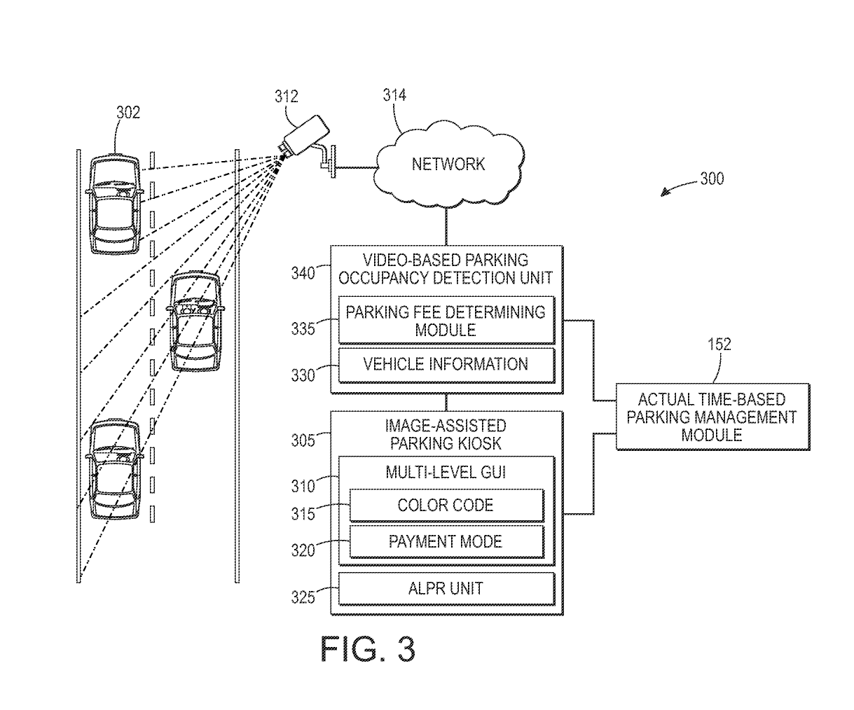

FIG. 3 illustrates a block diagram of an actual time based parking management system 300, in accordance with the disclosed embodiments. Note that in FIGS. 1-5, identical or similar blocks are generally indicated by identical reference numerals. The actual time based parking management system 300 generally includes a video-based parking occupancy detection unit 340 configured with an image-assisted parking kiosk 305 to provide an automatic parking-time monitoring element. The actual time based parking management module 152 can be configured with the video-based parking occupancy detection unit 340 and/or the image-assisted parking kiosk 305. An image-capturing unit 312 (e.g., camera) associated with the video-based parking occupancy detection unit 340 and/or the image-assisted parking kiosk 305 captures an image of a vehicle 302 and parking space within an effective field of view.

It is important to note that the connections between, for example, the image-capturing unit 312 and parking space, and the image-capturing unit 312 and the image-assisted parking kiosk 305 do not need to be networked. In some embodiments, the image-capturing unit 312 can be hardwired or integrated with, for example, the video-based parking occupancy detection unit 340 or the image-assisted parking kiosk 305. The image-capturing unit 312, the video-based parking occupancy detection unit 340, and the image-assisted parking kiosk 305 can also be hardwired or combined into a single unit in some embodiments.

The image-capturing unit 312 can be deployed on site to monitor a parking spot. In general, the parking kiosk 305 serves to regulate parking for a run of parking spaces. The parking kiosk 305 can be augmented with an image display capability and a plurality of functions such as, for example, touch screen, mouse, and/or selecting and entering buttons. The vehicle 302 can be, for example, automobiles, cars, trucks, vans, buses, motor homes, tankers, motorcycles, or other vehicles, etc., as well as trailers of all kinds in-tow.

The image-capturing unit 312 can be operatively connected to the image-assisted parking kiosk via a network 314. Note that the image-capturing unit 312 described in greater detail herein are analogous or similar to the image-capturing unit 108 of the data-processing system 100, depicted in FIG. 1. The image-capturing unit 312 may include built-in integrated functions such as image processing, data formatting, and data compression functions. Also, the unit 312 may include imager-positioning, range-finding, and a flash illuminator.

Note that the network 314 may employ any network topology, transmission medium, or network protocol. The network 314 may include connections such as wire, wireless communication links, or fiber optic cables. Network 314 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages.

The parking kiosk 305 includes a single-level or multi-level GUI 310 to start end a parking session. Various designs of GUI can be implemented to achieve the functionality discussed below. The vehicle 302 can be identified utilizing a user input provided to a GUI 310 of the parking kiosk 305 with the image displayed to start the parking session. A parking fee determining module 335 determines parking fee based on an actual time parked and payment can be made by a payment mode 320 (e.g., payment card/account/cash, etc.) after ending the parking session utilizing any of, for example: a user input provided to the GUI 310 with an image including the vehicle displayed at the time of termination, a video-based parking occupancy detection unit 340 which automatically detects the termination of the parking session, or a combination thereof.

The payment mode 320 can be implemented in the context of different payment options. For example, in a preferred embodiment, the payment mode 320 may involve simple cash wherein the excess cash is returned at the termination of parking, similar to a vending machine. In another embodiment, payment mode 320 may involve, for example, a payment card and/or a deduction from an account (e.g., for pre-registered users). The payment card (e.g., credit/debit) swiped will not be charged until the user ends the parking session. The kiosk 305 can be integrated with an ALPR unit 325 in order to track and provide evidence of parking usage after ending the parking session based on the actual time parked thereby deterring abuse providing a layer of security, and optionally providing an automated billing system for registered users 149.

The video-based parking occupancy detection unit 340 configured with the actual time based parking management module 152 can transmit a snapshot of the parking region of interest monitored by the parking management system per request from the parking kiosk 305. The parking kiosk 305 can transmit the information of vehicle identification 330 from the user 149. Additionally, the video-based parking occupancy detection unit 340 may transmit other useful information to facilitate an easier process for the user 149 and a parking enforcement staff. The information may include a list of vehicles claimed/identified or unclaimed, vehicle locations and sizes, and how the vehicle is claimed (e.g., by user input provided to the GUI of the parking kiosk, or by pre-registered smart-phone user, etc.).

The information between the kiosk 305 and the video-based parking occupancy detection unit 340 can be compared to enforce parking regulations and reservations, or safeguard against errors of video-based parking occupancy detection unit 340. The parking kiosk 305 configured with the actual time based parking management module 152 may receive images from the video-based parking occupancy detection unit 340 on demand, and the parking fee can be calculated. The detected vehicle identification can be presented in the form of color coding scheme, a highlighting with a box, or text messages based on detected information, to speed up the process and provide an enhanced user experience.

FIG. 4 illustrates a high level flow chart of operations illustrating logical operational steps of a method 400 for providing actual time based parking charge model, in accordance with the disclosed embodiments. It can be appreciated that the logical operational steps shown in FIG. 4 can be implemented or provided via, for example, a module such as module 152 shown in FIG. 2 and can be processed via a processor such as, for example, the processor 101 shown in FIG. 1. Initially, as indicated at block 410, the video-based parking occupancy detection unit 340 can be configured in association with the image-assisted parking kiosk 305 to provide an automatic parking-time monitoring element.

The image with respect to the vehicle 302 parked onsite can be captured by the image-capturing unit 312 associated with the video-based parking occupancy detection unit 340 and/or the image-assisted parking kiosk 305, as shown at block 420. The operation depicted at block 420 can thus involve capturing an image with respect to a vehicle parked at a parking section that contains one or more parking spaces. The vehicle 302 can be identified utilizing the image displayed on the GUI 310 of the parking kiosk 305 to start the parking session, as indicated at block 430. The operation depicted at block 420 generally involves identifying the vehicle (or vehicles) via input (e.g., user input, a selection, etc.) provided to a GUI such as GUI 310 displaying the image to initiate the parking session with respect to the parking space(s).

The parking fee can be calculated based on the actual time the vehicle is parked in the parking space, as depicted at block 440. Payment can be made by a payment mode 320 after ending the parking session utilizing the vehicle image displayed on the GUI 310, as depicted at block 440. That is, the operation illustrated at block 440 can involve accepting payment of the parking fee by the payment mode after the parking session terminates utilizing one or more of, for example: an input provided to the graphical user interface wherein an image including the vehicle is displayed concurrently with termination of the parking session; or a video-based parking occupancy detection unit which automatically detects termination of the parking session, or a combination thereof.

A user 149 can identify the vehicle 302 via the image-assisted parking kiosk 305 and can render payment based on, for example, the actual time parked. Note that the parking kiosk 305 may also contain or include the image-capturing unit 312 and can acquire an image of the user 149 as he/she initiates and/or terminates the parking session. The images of the user 149 may be also employed to automatically re-identify the user's vehicle 302 while ending the parking session and to serve as evidence in case of, for example, non-payment or future payment dispute. The actual time based parking charge method 400 can be applied to an on-street parking scenario by augmenting image capability and integrating the video-based parking occupancy detection unit 340 with the parking kiosk 305 and without depending on the user 149 to possess a mobile communications device or other such devices.

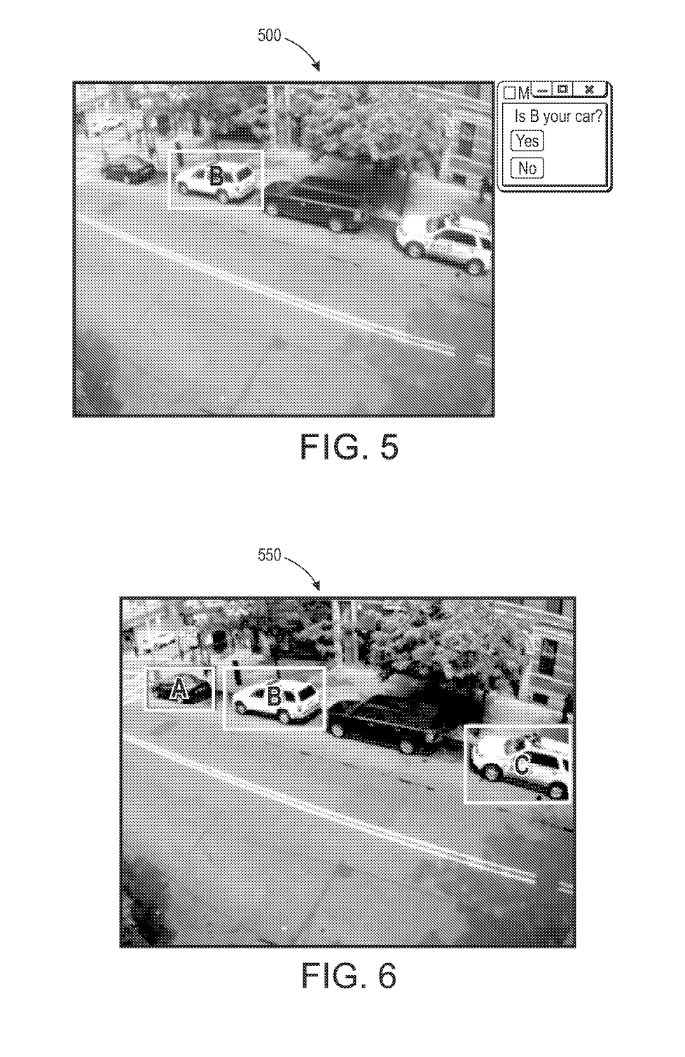

FIGS. 5-6 respectively illustrate an example of a multi-level GUI 500 and GUI 550 of the parking kiosk 305, in accordance with an embodiment. The image-assisted parking kiosk 305 permits the user 149 to identify the vehicle 305 for starting the parking session or re-identify the vehicle 305 for ending the parking session. The multi-level GUI 500 can display a parked vehicle B based on the most recently detected vehicle by the video-based parking occupancy detection unit 340 in case of starting a session or based on user-face recognition in case of ending a session.

If the parked vehicle 302 belongs to the user 149, the parking session can be started or payment can be processed if end of session. If the parked vehicle 302 does not belong to the user 149, the next level of GUI can be displayed to select the user's vehicle. Another option is to skip the first step (GUI 500) and display the GUI 550 to select the vehicle 302 by the user 149. It is also possible up-front to prompt the user 149 to indicate whether he or she desires to initiate or terminate a parking session and then decide which GUI to use. Note that various designs of GUI can be employed to perform the following functionalities: allowing user to indicate his/her vehicle on the displayed image, allowing user to start or end parking session, etc., as discussed earlier. The example GUI provided here is only for illustration purpose.

The detected vehicle identification can be presented in a form of color-coding scheme based on information such as whether the detected vehicle has been claimed. For example, a vehicle that has been claimed by another user (e.g., car-A) can be color coded as green (in terms of the text imposed on the vehicle and/or the box imposed around the vehicle), while coded as red otherwise (e.g., car-B and car-C), as shown in FIG. 6. This method of color coding scheme can assist the user by speeding up the process and providing a better user experience, since the user only needs to identify his/her vehicle from among those vehicles coded in red. Note that other presentation strategies can achieve the same purpose as color coding scheme such as: (1) highlighting unclaimed vehicles if the user wants to start a session, while highlighting claimed vehicles with boxes if the user wants to end a session, and (2) providing different text messages based on information such as claimed/unclaimed, start or end of session, etc.

Note that the system 300 can be easily augmented to include pre-registered mobile communications device parkers. Furthermore, a theft and vandalism detection option can be offered via the GUI 310 of the parking kiosk 305. Similarly, reservations can be made through, for example, a computer network (e.g., the Internet) and executed. Reservation information can be visually posted via the display 310 of the kiosk 305 and also made known in alternative ways to other (non-reserved) parkers (e.g., by a visible e-sign, a mobile app, etc.). The system 300 and method 400 does not place additional requirements on the user (smart phone or mobile device, or pre-registration) and requires minimal changes from current practice (e.g., payment by cash or credit card will still work in this system) while offering the preferred actual time based parking charge model.

Optionally, the system 300 may examine the parked vehicle 302 and provide feedback to the user 149 when the parking is unacceptable, e.g., excessive wasted space, or parked too close to the next vehicle, or parked in a no-parking section such as hydrant or driveway. The user 149 can be required to re-park the vehicle 302 before the parking request is accepted through the kiosk 305. The actual time based parking charge system 300 is especially suitable for a non-dosed arrangement such as on-street parking management, utilizing user-initiated starting and ending of parking sessions, enabled by image-based presentation at the parking kiosk 305, and communication between the kiosk 305 and the video-based parking occupancy detection unit 340.

Based on the foregoing, it can be appreciated that a number of embodiments, preferred and alternative, are disclosed herein. For example, in one embodiment, a time based parking management method can be implemented, which can include the steps or logical operations of capturing an image with respect to a vehicle parked at a parking section containing one or more parking spaces; identifying the vehicle via input provided to a graphical user interface displaying the image to initiate a parking session with respect to the parking space(s); calculating a parking fee based on an actual time the vehicle is parked on the parking space(s); and accepting payment of the parking fee by a payment mode after the parking session terminates utilizing one or more of, for example: input provided to the graphical user interface wherein an image including the vehicle is displayed concurrently with termination of the parking session; or a video-based parking occupancy detection unit which automatically detects termination of the parking session, or a combination thereof.

In another embodiment, the step or logical operation of capturing an image with respect to a vehicle parked on one or more parking spaces can further include the step or logical operation of capturing the image with respect to the vehicle parked on the parking space(s) utilizing an image-capturing unit. In yet another embodiment, the image-capturing unit can be associated with a video-based parking occupancy detection unit and/or an image-assisted parking kiosk. In still another embodiment, a step or logical operation can be implemented for configuring the video-based parking occupancy detection unit in association with the image-assisted parking kiosk in order to provide an automatic parking-time monitoring element.

In another embodiment, a step or logical operation can be provided for integrating the image-assisted parking kiosk with an automatic license plate recognition unit in order to make payment after ending the parking session based on the actual time parked thereby deterring abuse and providing a layer of security. In still another embodiment, a step or logical operation can be provided for capturing a user image to automatically re-identify the user of the parked vehicle while ending the parking session in order to serve as an evidence in case of a payment dispute. In yet another embodiment, a step or logical operation can be implemented for transmitting or sending a notification after the termination of the parking session. The notification can include, for example, a parking time, a payment amount, etc.

In another embodiment, a step or logical operation can be provided for configuring the image-assisted parking kiosk to include a pre-registered mobile communications device parker. In still another embodiment, steps or logical operations can be provided for transmitting a snapshot of the parking space(s) per request from the image-assisted parking kiosk wherein the image-assisted parking kiosk transmits the vehicle identification information; comparing information between the image-assisted parking kiosk and the parking occupancy detection unit to enforce a parking regulation and reservation and safeguard error of a parking occupancy detection unit; and presenting the detected vehicle identification in a form of, for example, a color-coding scheme, highlighting with a box, text messages based on the information, etc.

In yet another embodiment, steps or logical operations can be provided for configuring theft and vandalism detection via the graphical user interface associated with the image-assisted parking kiosk; and implementing parking reservations via a computer network and visually posting reservation information via the graphical user interface associated with the image-assisted parking kiosk.

In still another embodiment, steps or logical operations can be provided for examining the parked vehicle; providing feedback when parking with respect to the parking space(s) is unacceptable; and instructing a user to re-park the vehicle before a parking request is accepted by the parking kiosk.

In another embodiment, a time based parking management system can be implemented. Such a system can include, for example, a processor; and a computer-usable medium embodying computer program code, the computer-usable medium capable of communicating with the processor. In some instances, the aforementioned computer program code can include instructions executable by the processor and configured, for example, for: capturing an image with respect to a vehicle parked at a parking section containing one or more parking spaces; identifying the vehicle via input provided to a graphical user interface displaying the image to initiate a parking session with respect to the parking space(s); calculating a parking fee based on an actual time the vehicle is parked on the parking space(s); and accepting payment of the parking fee by a payment mode after the parking session terminates utilizing, for example; input provided to the graphical user interface wherein an image including the vehicle is displayed concurrently with termination of the parking session; or a video-based parking occupancy detection unit which automatically detects termination of the parking session, or a combination thereof.

In another embodiment, such instructions can be further configured for automatically detecting termination of the parking session. In yet another embodiment, such instructions can be further configured for capturing the image with respect to the vehicle parked parking space(s) utilizing an image-capturing unit.

In another system embodiment, the image-capturing unit can be associated with a video-based parking occupancy detection unit and/or an image-assisted parking kiosk. In another system embodiment, the video-based parking occupancy detection unit can be associated with the image-assisted parking kiosk in order to provide an automatic parking-time monitoring element. In another system embodiment, the image-assisted parking kiosk can be integrated with an automatic license plate recognition unit in order to make payment after ending the parking session based on the actual time parked thereby deterring abuse and providing a layer of security.

In still another embodiment, a processor-readable medium storing code representing instructions to cause a process for time based parking management can be implemented. Such code can include code to, for example: capture an image with respect to a vehicle parked at a parking section containing one or more parking spaces; identify the vehicle via input provided to a graphical user interface displaying the image to initiate a parking session with respect to the parking space(s); calculate a parking fee based on an actual time the vehicle is parked on the parking space(s); and accept payment of the parking fee by a payment mode after the parking session terminates utilizing, for example: input provided to the graphical user interface wherein an image including the vehicle is displayed concurrently with termination of the parking session; or a video-based parking occupancy detection unit which automatically detects termination of the parking session, or a combination thereof. In other embodiments, the aforementioned code can further include code to automatically detect termination of the parking session. In still other embodiments, the image-capturing unit can be associated with a video-based parking occupancy detection unit and/or an image-assisted parking kiosk.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A time based parking management method, said method comprising:
capturing an image with respect to a vehicle parked at a parking section containing at least one parking space;
identifying said vehicle via input provided to a graphical user interlace displaying said image to initiate a parking session with respect to said at least one parking space;
calculating a parking fee based on an actual time said vehicle is parked on said at least one parking space; and
accepting payment of said parking fee by at least one payment mode after said parking session terminates utilizing at least one of: input provided to said graphical user interlace wherein an image including said vehicle is displayed concurrently with termination of said parking session; or a video-based parking occupancy detection unit which automatically detects termination of said parking session, or a combination thereof.

2. The method of claim 1 wherein capturing an image with respect to a vehicle parked on at least one parking space, further comprises:
capturing said image with respect to said vehicle parked on said at least one parking space utilizing an image-capturing unit.

3. The method of claim 2 wherein said image-capturing unit is associated with a video-based parking occupancy detection unit and/or an image-assisted parking kiosk.

4. The method of claim 3 further comprising configuring said video-based parking occupancy detection unit in association with said image-assisted parking kiosk in order to provide an automatic parking-time monitoring element.

5. The method of claim 4 further comprising integrating said image-assisted parking kiosk with an automatic license plate recognition unit in order to make payment after ending said parking session based on said actual time parked thereby deterring abuse and providing a layer of security.

6. The method of claim 1 further comprising capturing a user image to automatically re-identify said user of the parked vehicle while ending said parking session in order to serve as an evidence in case of a payment dispute.

7. The method of claim 1 further comprising sending a notification after said termination of said parking session, said notification comprising at least one of: a parking time and a payment amount.

8. The method of claim 4 further comprising configuring said image-assisted parking kiosk to include a pre-registered mobile communications device parker.

9. The method of claim 4 further comprising:
transmitting a snapshot of said at least one parking space per request from said image-assisted parking kiosk wherein said image-assisted parking kiosk transmits said vehicle identification information;
comparing information between said image-assisted parking kiosk and said parking occupancy detection unit to enforce a parking regulation and reservation and safeguard error of a parking occupancy detection unit; and
presenting said detected vehicle identification in a form of at least one of a color-coding scheme, a highlighting with a box, and text messages based on said information.

10. The method of claim 4 further comprising at least one of:
configuring theft and vandalism detection via said graphical user interface associated with said image-assisted parking kiosk; and
implementing parking reservations via a computer network and visually posting reservation information via said graphical user interface associated with said image-assisted parking kiosk.

11. The method of claim 4 further comprising:
examining said parked vehicle;
providing feedback when parking with respect to said at least one parking space is unacceptable; and
instructing a user to re-park said vehicle before a parking request is accepted by said parking kiosk.

12. A time based parking management system, said system comprising:
a processor; and
a computer-usable medium embodying computer program code, said computer-usable medium capable of communicating with the processor, said computer program code comprising instructions executable by said processor and configured for:
capturing an image with respect to a vehicle parked at a parking section containing at least one parking space;
identifying said vehicle via input provided to a graphical user interface displaying said image to initiate a parking session with respect to said at least one parking space;
calculating a parking fee based on an actual time said vehicle is parked on said at least one parking space; and
accepting payment of said parking fee by at least one payment mode after said parking session terminates utilizing at least one of: input provided to said graphical user interface wherein an image including said vehicle is displayed concurrently with termination of said parking session; or a video-based parking occupancy detection unit which automatically detects termination of said parking session, or a combination thereof.

13. The system of claim 12 wherein said instructions are further configured for automatically detecting termination of said parking session.

14. The system of claim 12 wherein said instructions are further configured for capturing said image with respect to said vehicle parked on said least one parking space utilizing an image-capturing unit.

15. The system of claim 14 wherein said image-capturing unit is associated with a video-based parking occupancy detection unit and/or an image-assisted parking kiosk.

16. The system of claim 15 wherein said video-based parking occupancy detection unit is associated with said image-assisted parking kiosk in order to provide an automatic parking-time monitoring element.

17. The system of claim 14 wherein said image-assisted parking kiosk is integrated with an automatic license plate recognition unit in order to make payment after ending said parking session based on said actual time parked thereby deterring abuse and providing a layer of security.

18. A processor-readable medium storing code representing instructions to cause a process for time based parking management, said code comprising code to:
capture an image with respect to a vehicle parked at a parking section containing at least one parking space;
identify said vehicle via input provided to a graphical user interface displaying said image to initiate a parking session with respect to said at least one parking space;
calculate a parking fee based on an actual time said vehicle is parked on said at least one parking space; and
accept payment of said parking fee by at least one payment mode after said parking session terminates utilizing at least one of: input provided to said graphical user interface wherein an image including said vehicle is displayed concurrently with termination of said parking session; or a video-based parking occupancy detection unit which automatically detects termination of said parking session, or a combination thereof.

19. The processor-readable medium of claim 18 wherein said code further comprises code to automatically detect termination of said parking session.

20. The processor-readable medium of claim 18 wherein said image-capturing unit is associated with a video-based parking occupancy detection unit and/or an image-assisted parking kiosk.
